(19) United States
(12) Patent Application Publication
(10) Pub. No.: US 2023/0102182 A1
(43) Pub. Date: Mar. 30, 2023

(54) Incident Management System

(71) Applicant: Kokomo Solutions, Inc., Northbrook, IL (US)

(72) Inventor: Daniel Jongdae Lee, Northbrook, IL (US)

(21) Appl. No.: 17/658,890

(22) Filed: Apr. 12, 2022

Related U.S. Application Data
(60) Provisional application No. 63/173,868, filed on Apr. 12, 2021.

(51) Int. Cl. G06Q 50/26

(52) U.S. Cl. CPC G06Q 50/265

(57) ABSTRACT

An emergency operation center which can be either a physical or virtual location to which individuals report in order to organize data and make sure it is received by the intended individuals (i.e. first responders, parents, citizens, school administration, etc.). An incident management system is engaged by sensors escalating to activation and sending the information to the emergency operation center. The information sending is initiated from a direct link in an incident detail view and sends historical data on incidents to the emergency operation center commander. The emergency operation center is automatically engaged with the activation from Internet of Things devices such as a gunshot detector, a scream detector, a panic button, and/or an activation pattern. The activation pattern is determined by using the level of confidence in detecting an incident by calculating the sequence of sensors to determine the level of emergency to activate an emergency operation center automatically. The incident management system relies on anonymous reporting by using a confidence scoring system.

### RELATED APPLICATION

The present application claims the filing priority of U.S. Provisional Application No. 63/173,868 titled “Incident Management System” and filed on Apr. 12, 2021. The '868 application is also hereby incorporated by reference.

### TECHNICAL FIELD OF THE INVENTION

The present invention relates to incident management systems (IMS). Particularly, the invention relates to methods for establishing and operating an IMS including use of an Emergency Operation Center (EOC) and an Emergency Support System (ESS).

### BACKGROUND OF THE INVENTION

When an emergency occurs or there is a disruption to a business, school, or a community in general, organized teams will respond in accordance with established plans, protocols, and procedures. Public emergency services, including first responders, may be called on to assist. Private contractors may also be engaged, as additional resources and skills may be needed. However, inquiries and communication to, from and between news media, community members, business owners, employees and their families, and local officials may overwhelm telephone lines and other resources, hampering efforts to carry out the established plans, protocols, and procedures.

An IMS is “the combination of facilities, equipment, personnel, procedures and communications operating within a common organizational structure, designed to aid in the management of resources during incidents.”

The National Incident Management System (NIMS) was established by FEMA and includes an Incident Command System (ICS). NIMS is used as the standard for emergency management by many public agencies in the United States, for both planned and emergency events. Further, businesses with organized emergency response teams that interface with public emergency services can benefit from using an ICS. An ICS is typically well-suited for managing disruptions of business operations. Public information and crisis communications are an integral part of any quality ICS structure.

When an incident occurs, incident stabilization activities (e.g., firefighting, crowd control, damage assessment, property conservation) may be underway at the scene of the incident. Others assigned to support incident stabilization, business continuity or crisis communications activities typically report to an emergency operations center (EOC). The EOC is a physical or virtual location from which coordination and support of incident management activities can be directed.

While an IMS is used by public or government agencies to manage emergencies, there is often difficulty in collecting, storing, recording, and addressing all information needed during an incident in real time. Until the invention of the present application, these and other problems in prior art Incident Management Systems went either unnoticed or unsolved by those skilled in the art. The present disclosed system provides incident management which performs multiple functions with the associated EOC and ESS without sacrificing safety or effectiveness.

### SUMMARY OF THE INVENTION

There is disclosed herein an improved incident management system which avoids the disadvantages of prior systems while affording additional structural and operating advantages.

Embodiments of the incident management system are shown and described herein, including an emergency operation center and emergency support services. The emergency operation center can be either a physical or virtual location where individuals report to in order to organize data and make sure it is received by the intended individuals (i.e. first responders, parents, citizens, school administration, etc.).

In another exemplary embodiment of the invention, the incident management system is engaged by sensors escalating to activation and sending the information to the emergency operation center. The information sending is initiated from a direct link in an incident detail view and sends historical data on incidents to the emergency operation center commander.

In another exemplary embodiment, the emergency operation center is automatically engaged with the activation from Internet of Things (IoT) devices such as a gunshot detector, a scream detector, a panic button, and/or an activation pattern.

This activation pattern is determined by using the level of confidence in detecting an incident by calculating the sequence of sensors to determine the level of emergency to activate an emergency operation center automatically.

In another exemplary embodiment, the incident management system relies on anonymous reporting by using a confidence scoring system. The confidence scoring system takes into account metadata consisting of geolocation, degree of missing data, and historic information of triage decisions in an anonymous data collection process.

In another exemplary embodiment, volunteers are employed based on proximity.

In another exemplary embodiment, the incident management system is downsized to a personal circle of members who can share, alert, and communicate between each other.

The system operates using cloud-based software responsive to any number of sensors, alarms, and such.

The incident management system may be configured to allow first responders to improve communication and enhance operational efficiency. It will allow on-cite sharing of incident data, provide immediate access to backend storage drive(s) and allow first responders to transfer videos and pictures between mobile devices and desktop computers.

Another embodiment allows for day-to-day incident reporting from school grounds. If an incident breaks out at a school this invention will notify the proper authorities whether that is school administration or first responders. It can also send out important information regarding the incident to parents at the appropriate time.

And still another embodiment provides a Portal for First Responders to prioritize submitted incident reports. In this portal First Responders can view the GPS location of the incident, accept the incident, reject the incident, suggest instructions for their employees, volunteers, or victims.

Another embodiment allows for citizens to connect with their city by providing access to useful information related to the city such as weather forecast, real-time traffic, breaking news, and information.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a schematic illustrating an embodiment for auto-activation of EOC from triggers using mission critical sensors;

FIG. 2 is a schematic illustrating an embodiment for activation of EOC from an emergency event;

FIG. 3A is a first part of a flow chart illustrating embodiments of a credibility scoring system based on geolocation information;

FIG. 3B is a second part of the flow chart of FIG. 3A, with connection at points (a), (b) and (c);

FIG. 3C is a third part of the flow chart of FIGS. 3A and 3B, with connection to FIG. 3B at points (d), (e), (f) and (g);

FIG. 4A is a first part of a flowchart illustrating an embodiment of a preferred mobile application and preferred functionality;

FIG. 4B is a second part of the flow chart of FIG. 4A, with connection at points (a), (b), (c) and (d);

FIG. 5A is a first part of a detailed flowchart for an embodiment of the AR module, illustrating “non-emergency” and “emergency” information flow, with point (a) connecting to point (a′) and point (b) connecting to FIG. 5B;

FIG. 5B is a second part of the detailed flowchart of FIG. 5A, with connection via point (b), and point (c) connecting to FIG. 5C;

FIG. 5C is a third part of the detailed flowchart of FIGS. 5A and 5B, with connection to FIG. 5B via point (c);

FIG. 6A is a first part of an information flowchart for an embodiment of the AR module once an incident report is made;

FIG. 6B is a second part of the information flowchart of FIG. 6A, with connection via points (a) and (b);

FIG. 7A is a first part of a multi-level illustration of the disclosed system showing both anonymous and non-anonymous reporting of events;

FIG. 7B is a second part of the multi-level illustration of FIG. 7A, with connection via points (a), (b), (c) and (d) to FIG. 7A;

FIG. 7C is a third part of the multi-level illustration of FIG. 7A, with connection via points (e), (f), (g) and (h) to FIG. 7B;

FIG. 8 is a diagram illustrating an embodiment of a social volunteer management and activation system based on proximity and an opt-in status;

FIG. 9 is a schematic illustrating an embodiment of a decentralized storage of personal data from centralized SaaS service;

FIG. 10A is a first part of a schematic illustrating an embodiment of the public safety cloud for consumers;

FIG. 10B is a second part of the schematic of FIG. 10A, with connection via point (a);

FIG. 10C is a third part of the schematic of FIG. 10A, with connection to FIG. 10B via points (b) and (c);

FIG. 11A is a first part of an illustrated flowchart showing an embodiment of the overall operation of the disclosed system from event to resolution; and

FIG. 11B is a second part of the illustrated flowchart of FIG. 11A, with connection via point (a).

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

As used in the following detailed description, several terms and phrases have specific definitions. The term “incident management system (IMS)” is defined as a collection of devices, systems, processes, and people that handle incident events. The term “incident” is defined as an event that (1) is not in real time, is after the fact, or is offline; (2) is entered into the system after a significant time has passed, such as a few hours to a few days; (3) requires follow-up, such as investigation, handling and communication over next few hours, days, weeks or months, once entered into system; and (4) is not an emergency (defined below). Examples of an incident include a non-life-threatening injury, harassment, fighting, traffic backup, etc. An “Emergency Operation Center (EOC)” is a command center where people handling an emergency (defined below) event report physically and virtually to handle various aspects throughout the emergency—i.e., to a resolution. Often, the start of a new EOC is referred to as “activation.” An “Emergency Support System (ESS)” is the system, including devices, processes and people, that handle an emergency by providing functionalities for users, such as notifications, communication, and collaborative functions. Finally, an “emergency” is defined as an event that (1) is occurring in real time; and (2) typically requires immediate attention over hours to days. Examples of an emergency for purposes of the present disclosure include life-threatening injury, natural disasters, active shooter, fire, and similar events. Events can and do escalate from an incident to an emergency. Accordingly, incidents are monitored throughout the event to determine whether activation of EOC is required.

As will be shown and described, the EOC can be activated in several ways. In a first scenario, activation is manually created from connected IoT devices, such as sensors/detectors, and a “panic button,” via a cloud-based app running on portable devices. A second scenario which can automatically trigger an activation is through use of sensors and a pattern recognition program. A third activation scenario is called “anonymous reporting” which uses a confidence scoring system for anonymous data collection process.

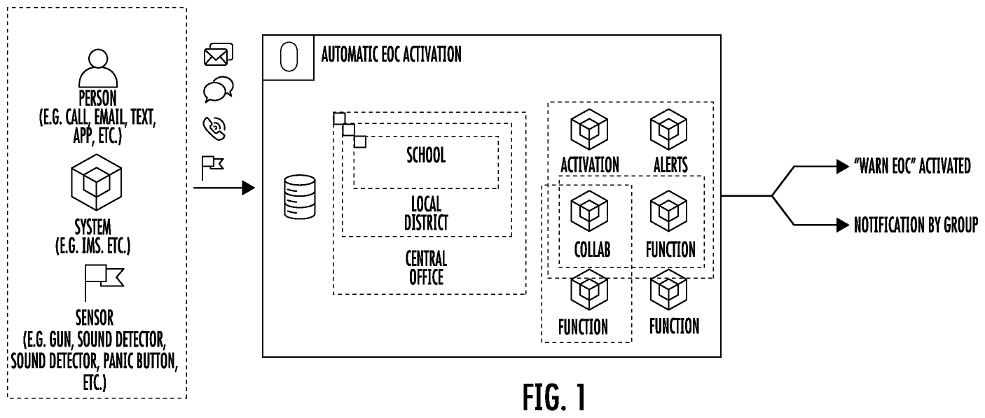

Referring to FIGS. 1-11, there is illustrated and herein described at least one embodiment of an incident management system (IMS). As can be seen in the numerous figures, the invention is comprised of many components and may be implemented in several stages. The system includes real-time and post-incident capabilities for information gathering.

FIG. 1 illustrates the placement of detectors or sensors in a defined area to detect specific events. Relatively speaking, the “area” may be small—e.g., a playground, a work area, a restaurant, etc.—medium sized—e.g., a grade school, professional office, a store, etc.—or large—e.g., a university campus, a corporate complex, a shopping mall, etc. At present, these events include gunshot, screams, and other loud noises which may be assignable to a known event—e.g., fighting, cursing, threatening language, running, etc. The detectors or sensors can be placed in a defined area, including about a periphery of the area, such as within a school and about the school grounds. Use of a “panic button” can be provided to authorized personnel, such as teachers, school administrators, security personnel, select students, and other staff (e.g., custodial workers, groundskeeper, etc.).

Gun shot or shooter detection systems are manufactured and sold by multiple companies throughout the U.S. and abroad. One such system is the Guardian Indoor Active Shooter Detection System sold by Shooter Detection Systems, Inc. Outdoor systems are also available, including the Boomerang Shooter Detection System, also by Shooter Detection Systems, Inc. Other sound detection systems are manufactured and sold by Axis Communications of Sweden. These, and other similar detection systems, can be incorporated into the present system of this disclosure.

The ESS can send out notifications, via email, text message, IM, voice-messaging, etc., to first-responders, parents, teachers and/or other personnel with instructions, information, etc., on the emergency event. Such communications may continue throughout the emergency event.

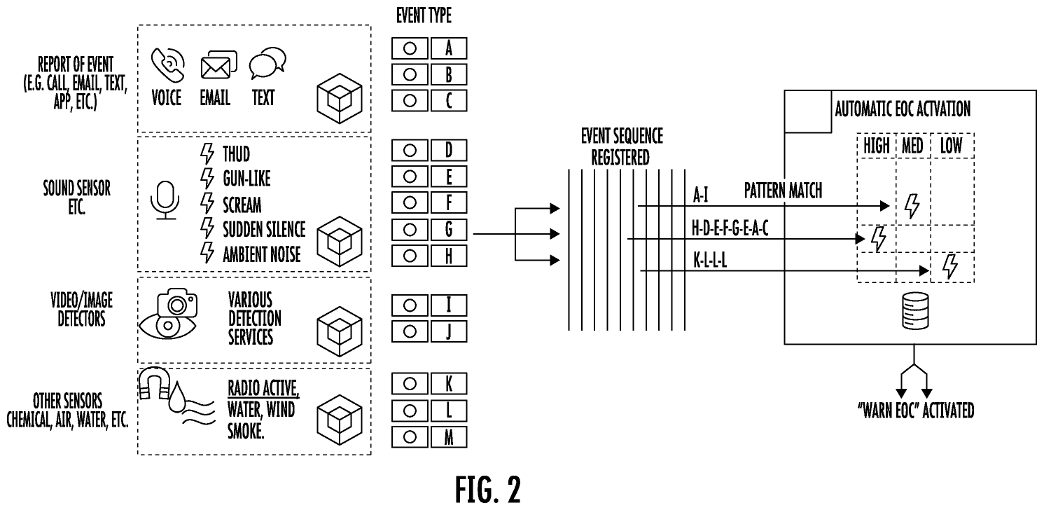

FIG. 2 illustrates scenarios for triggering an EOC. The event may be reported by, for example, a witness via a call, text, email or via a smart phone app. Alternatively, a scenario exists where a pattern of recognizable sounds (e.g., gun shot, screams, thud) can automatically trigger an EOC. A pattern recognition algorithm can assess the sequence of sounds, including intermittent silence while filtering out “white noise,” to apply a confidence score as to the likelihood of an emergency. The trigger may be the result of video/image detectors in the defined area. Finally, chemical, air, and/or water sensors may detect presents of a toxin or other hazard requiring notification of authorities. In each of these scenarios, the ESS can then respond accordingly with the necessary communication to required personnel.

In a preferred embodiment of the disclosed system, five (5) distinct though interconnected modules are utilized: Incident Management System (core system), Emergency Operation Center (EOC), Anonymous Reporting (AR) module, Volunteer Management module, and Emergency Pre-Planning System (EPS) module for first-responders. As previously noted, the IMS is for incident tracking, notification, workflow, tasks and includes AI for predictive analysis. Likewise, the EOC is a virtual dashboard to provide situational awareness, notification, and facilitate resource management. The AR module provides a “tip-line” with the ability to report ingestion and dissemination, and AI filtering for predictive analysis. The Volunteer Management System (VMS) module works with the IMS, EOC and AR modules to facilitate direction of people/volunteers as resources. Finally, the EPS module includes schematics, building floorplans, and way-finding, as well as maintaining HazMat inventory for facilities, as necessary.

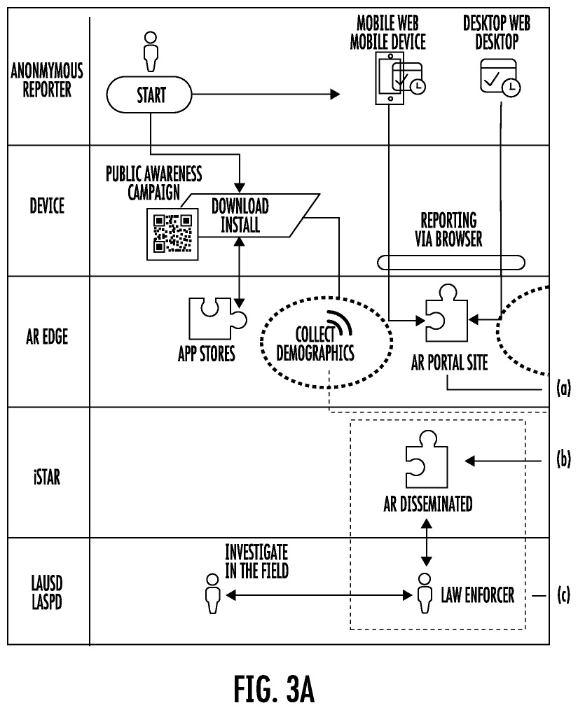

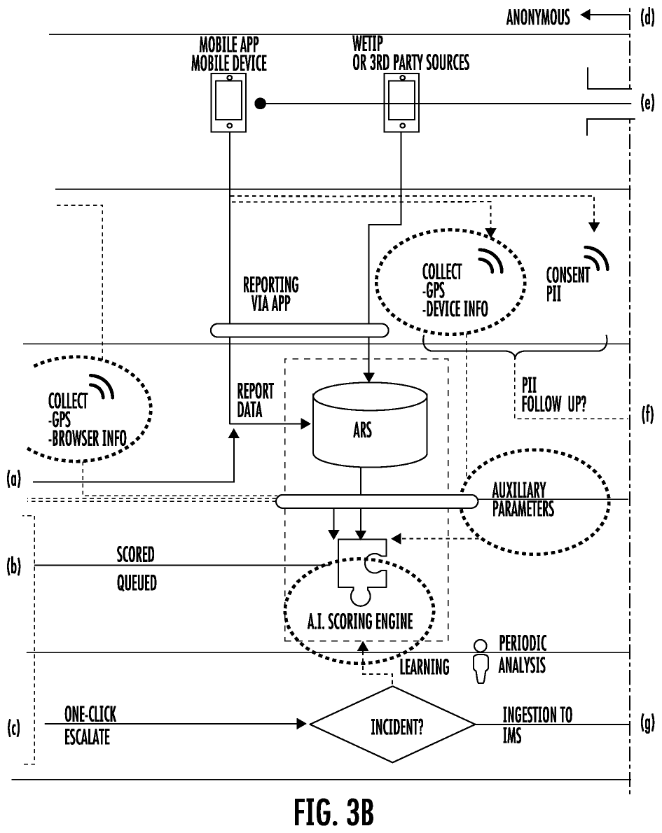

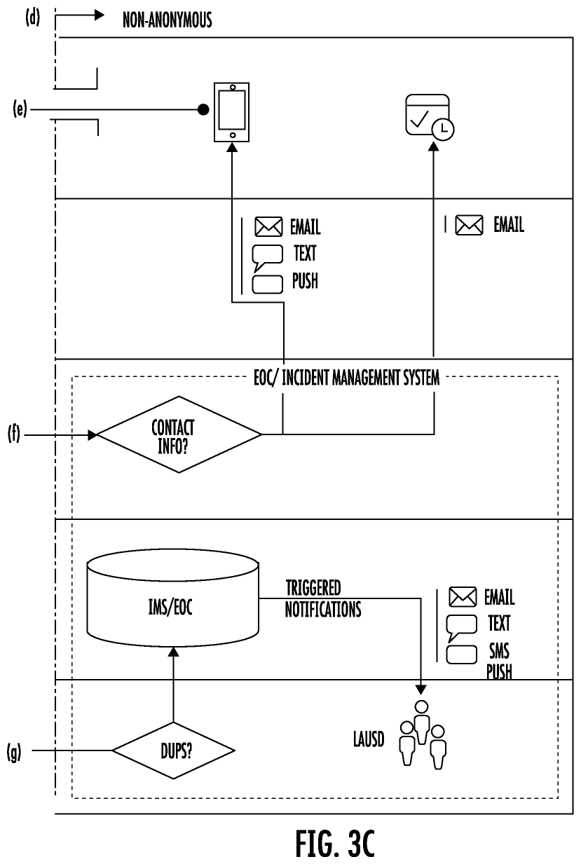

With reference to FIGS. 3A-3C, the AR module is an “out-of-the-box” cloud-solution that comes with a set of tools and services made available on the Internet, as well as on mobile devices via an app. The tools enable an organization to immediately promote, disseminate, and act on reports of events submitted anonymously. Reportable events could include, for example, a simple broken window or burnt-out light (facility management) to suspicious activity (security). The module is customizable to suit the intended needs based on the type of facility—i.e., grade school, high school, university, public facility, government building, restaurant, retail store, manufacturing facility, etc. The AR module provides comprehensive tools and services to collect, disseminate, and (when necessary) escalate events reported by the public. The SaaS offering comes with modern mobile applications and web portal to allow the general public to make reports anonymously. The system is equipped with AI-driven scoring to identify and save resources which might be wasted on incomplete reporting.

The AR module handles event reports from ingestion, processing through workflow, and responding with task management, robust notification via text, email and voice calls. Interfacing with the AR module is accomplished with accompanying mobile (IOS/Android), desktop (PC/Mac) and web applications.

FIGS. 3A-3C are intended to collectively illustrate the AI-driven credibility scoring system which can be based on geolocation information and missing information. That is, a credibility score can be provided to each report based on (1) amount and quality of missing entry information, (2) device type used for entry, (3) GPS location for information, (4) metadata collected, and (5) a human decision input (y/n) as to the credibility.

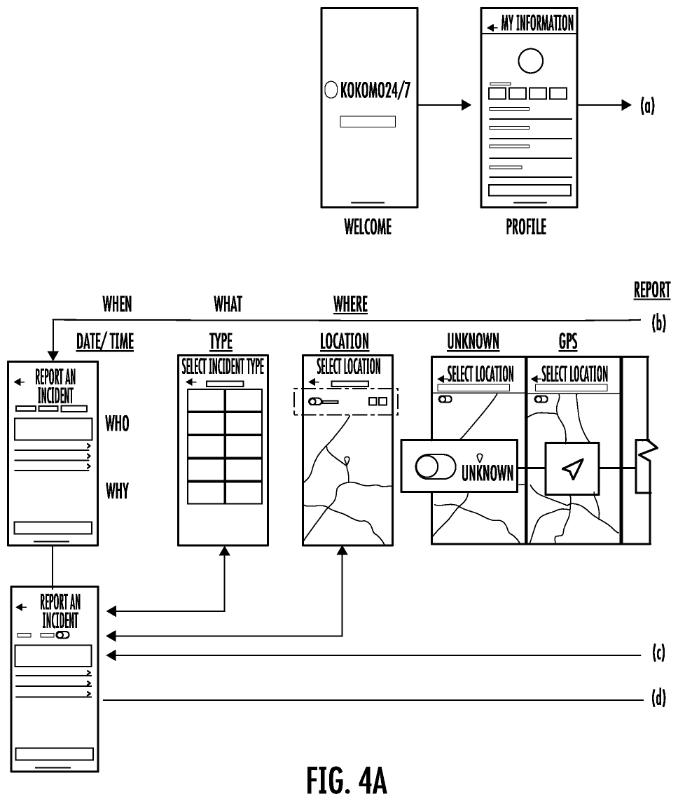

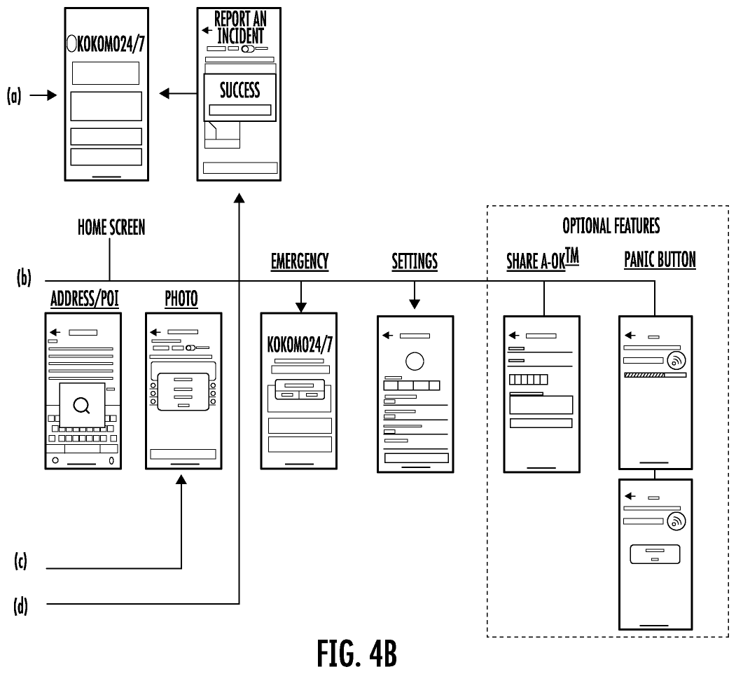

FIGS. 4A and 4B illustrate an embodiment of a preferred mobile application and functionality. The app preferably includes a profile and home screen for a user to begin a report. The app takes the user through several screens to collect information on the “Who,” “What,” “Where,” “When,” and “Why” of the event. Additional screens may allow for inclusion of other details, including photos. The app may also provide GPS labeling and “points of interest” (POI) identification, for cases where a user may be unable to give an accurate location of the event. Optional app functionality may provide a “panic button”. This feature may be reserved for specific authorized personnel, such as teachers, supervisors, and the like, to cut down on false alarms.

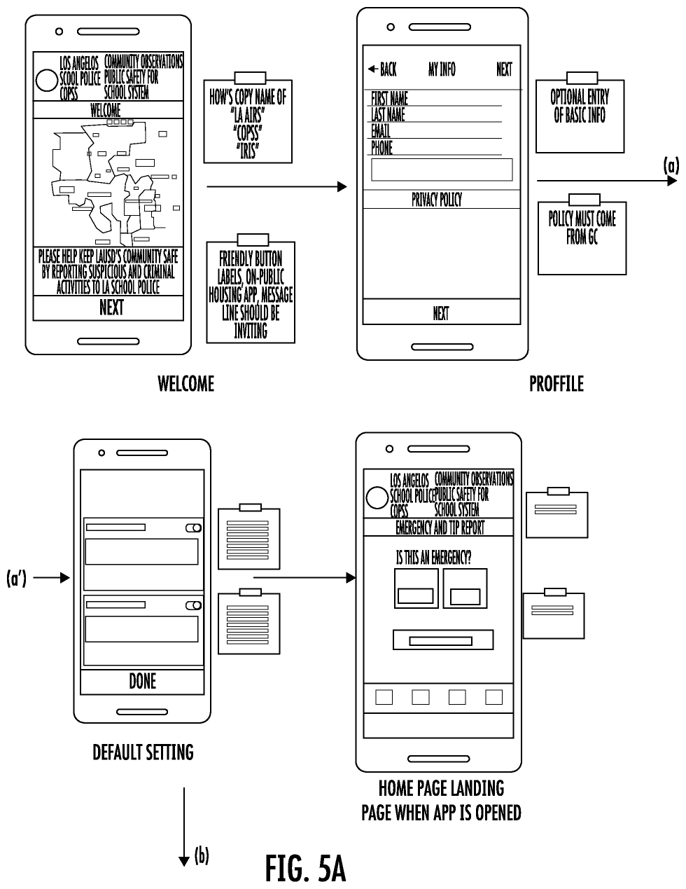

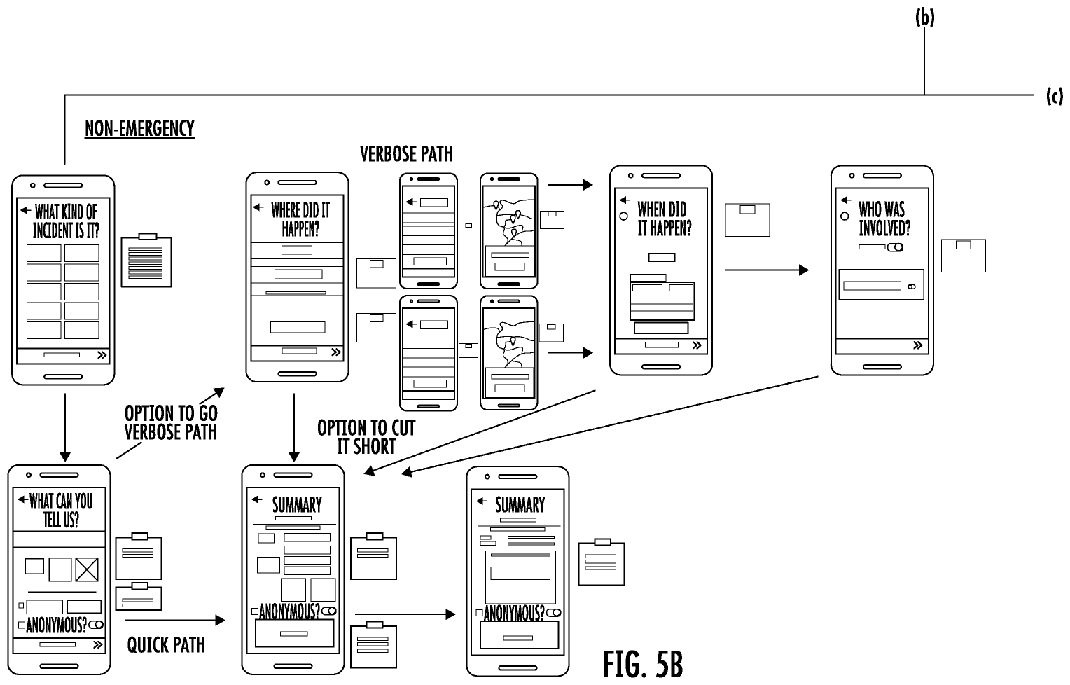

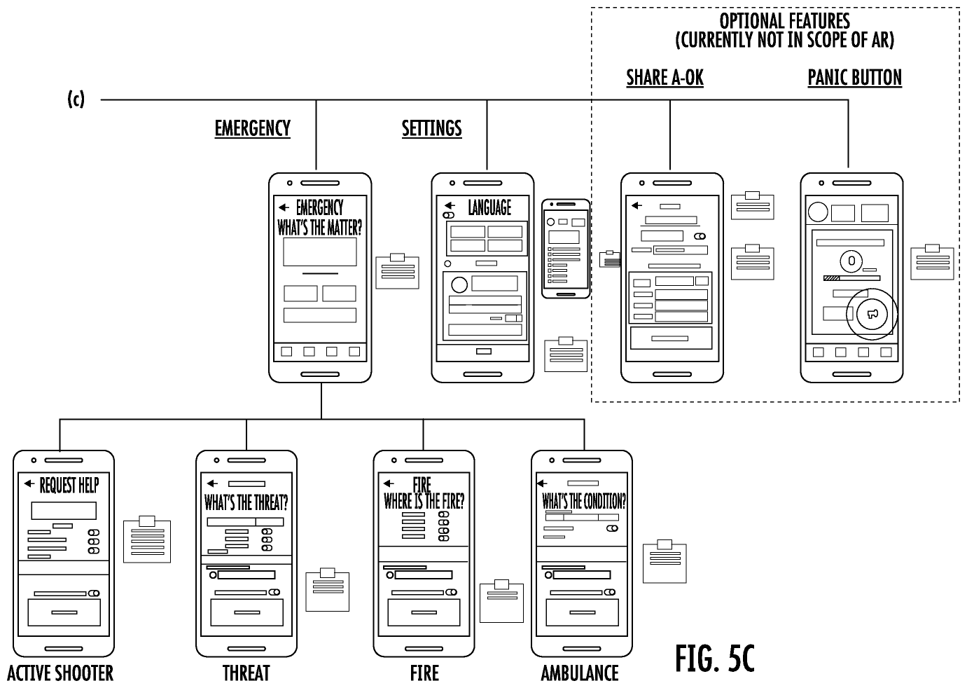

Referring to FIGS. 5A-5C, a more detailed flowchart for an embodiment of the AR module is shown, illustrating “non-emergency” and “emergency” information flow. The non-emergency reporting can take one of two paths, quick path or the verbose path. Each path includes an early option to jump to the other path. The emergency reporting includes selections for reporting “active shooter,” “threat,” “fire” and calling for an “ambulance.” Optional features for the AR module may include an “all clear” button and a panic button.

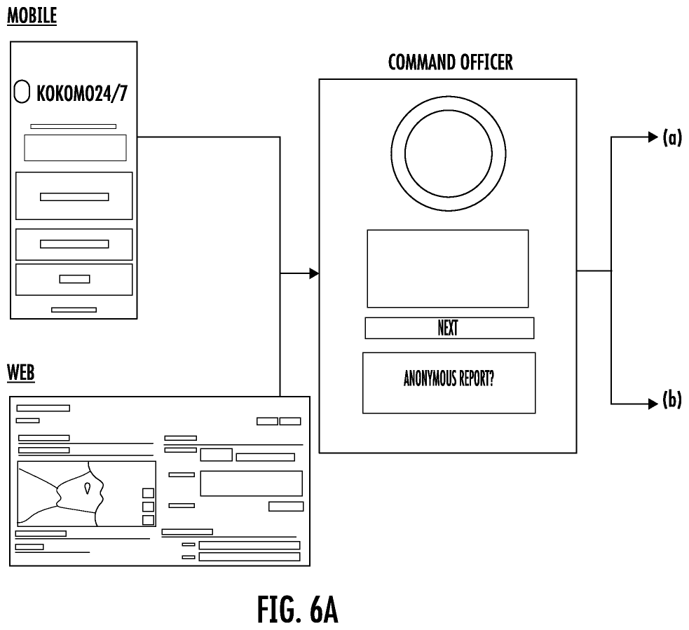

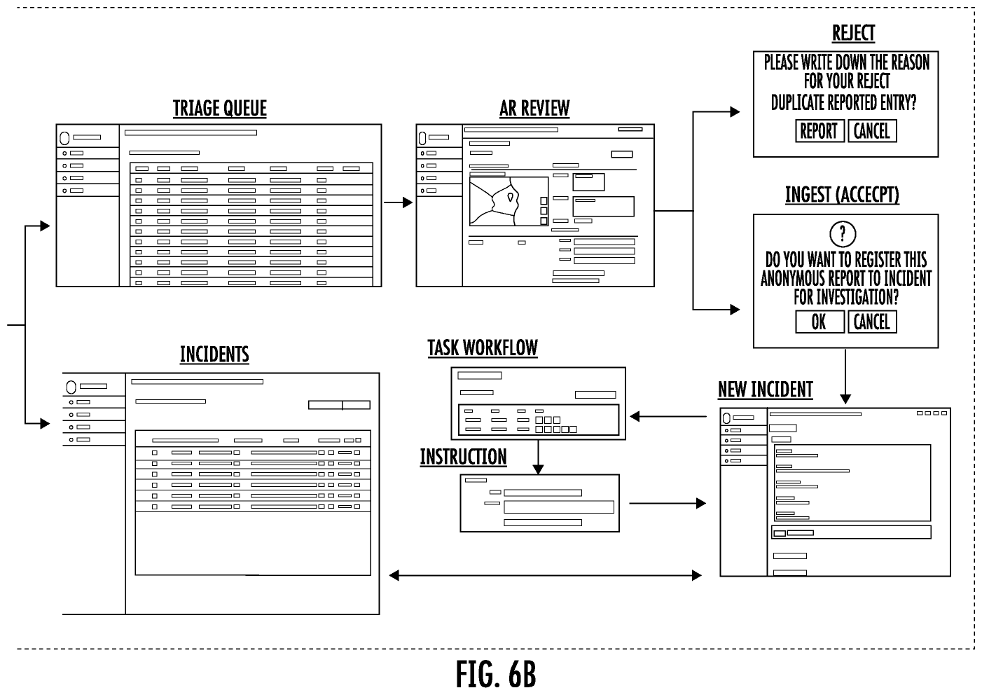

FIGS. 6A and 6B collectively illustrate an information flowchart for an embodiment of the AR module once an incident report is made. The user report, including any attached photos, flows from the electronic device (app) or computer (web page) to a command officer. Here the event is logged and triaged based on the information collected. Multiple reports on the same incident may be combined, which increases the credibility of the report. The anonymous report is then reviewed until it can be “accepted” as credible or “rejected” as noncredible. A new incident event is recorded with this decision. The accepted events then go on for further processing, including workflow command and instructions. A status of all reported events is maintained and updated, preferably in real-time.

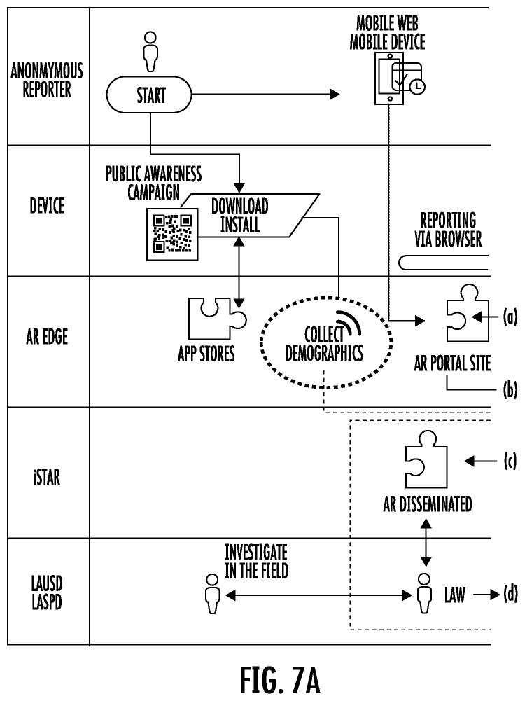

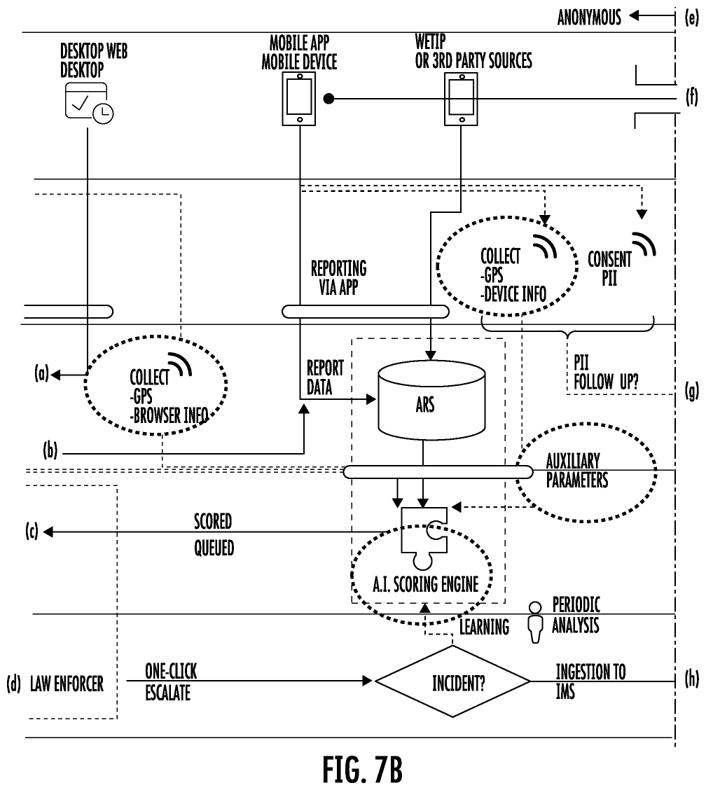

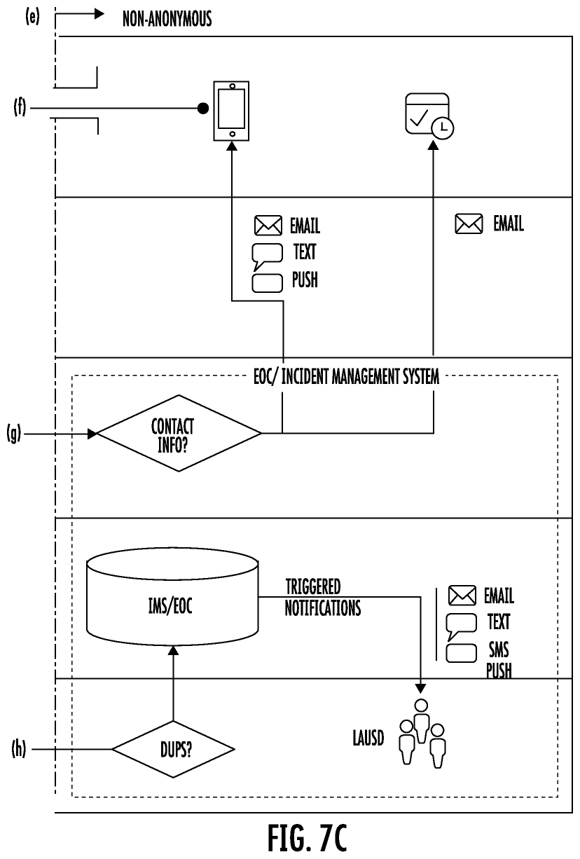

FIGS. 7A through 7C collectively illustrate an embodiment of a multi-level platform of the disclosed system showing both anonymous and non-anonymous reporting of events. Use of both mobile devices and computers are contemplated in the chart. Further, the IMS module is also shown as reported events are analyzed and a response is considered and implemented with notification to the proper resources, including possible volunteers.

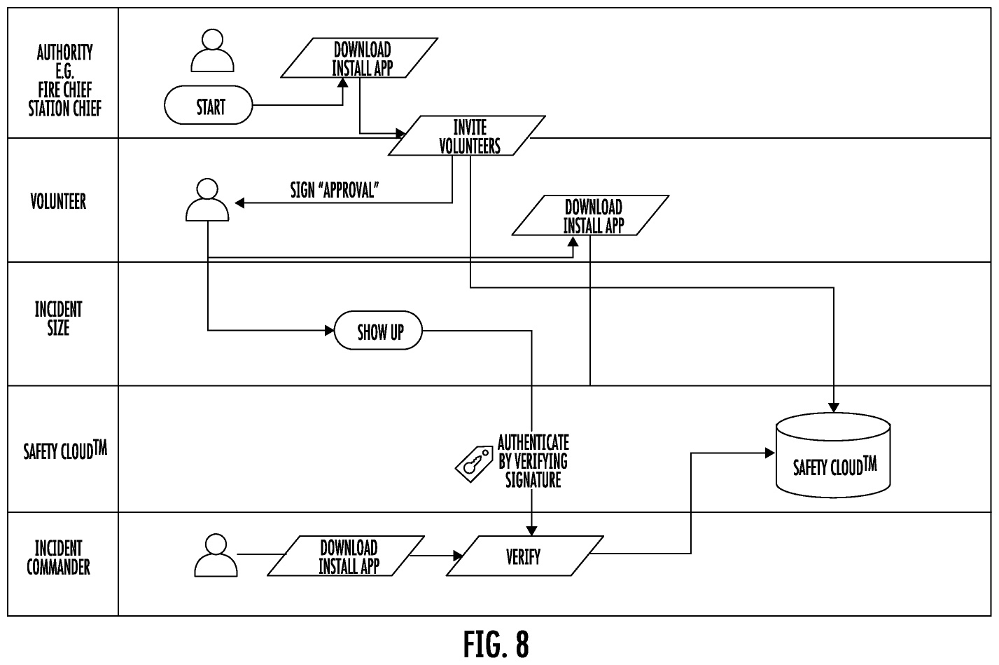

FIG. 8 illustrates features of the VMS module based on proximity to the event and the “opt-in” status of volunteers. The VMS module has functionality to permit the invitation of volunteers, the sign-up of volunteers, request for volunteers, and the authentication and verification of volunteers on site by an incident commander.

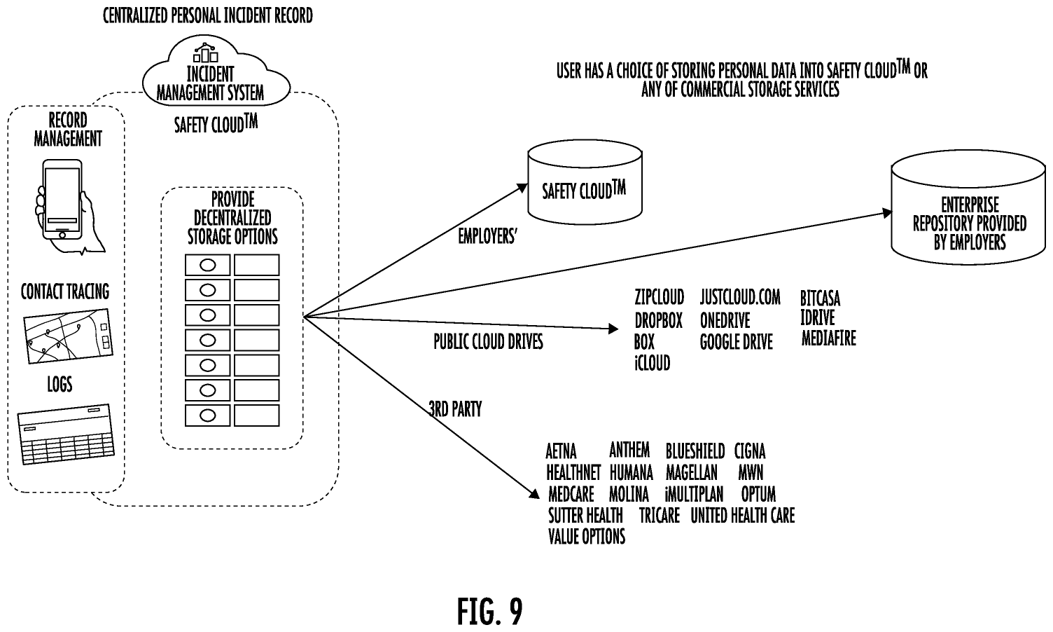

FIG. 9 illustrates the decentralized storage of personal data from a centralized SaaS service.

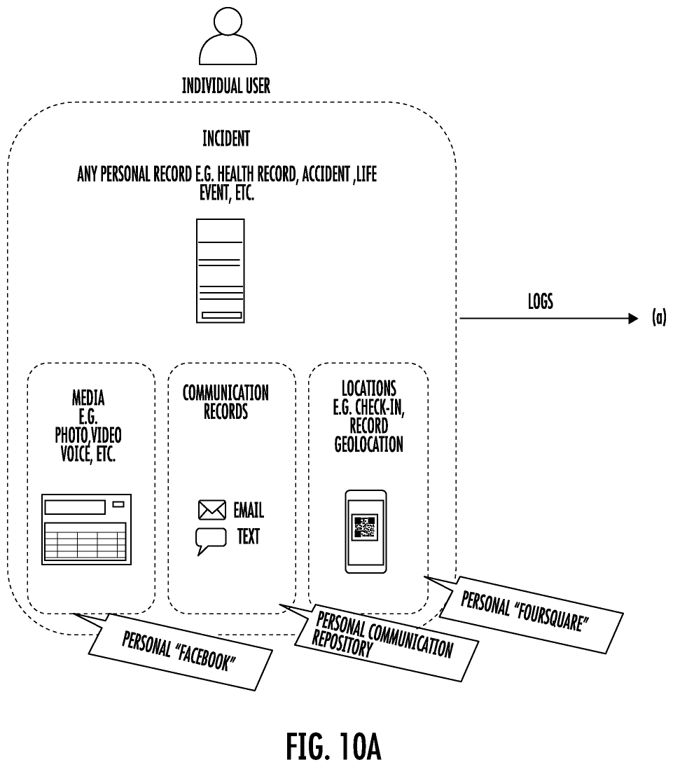

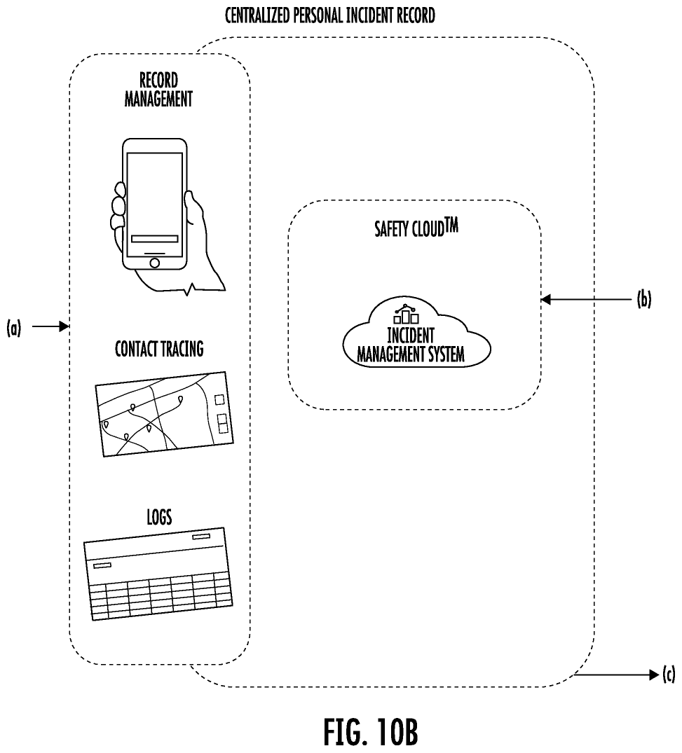

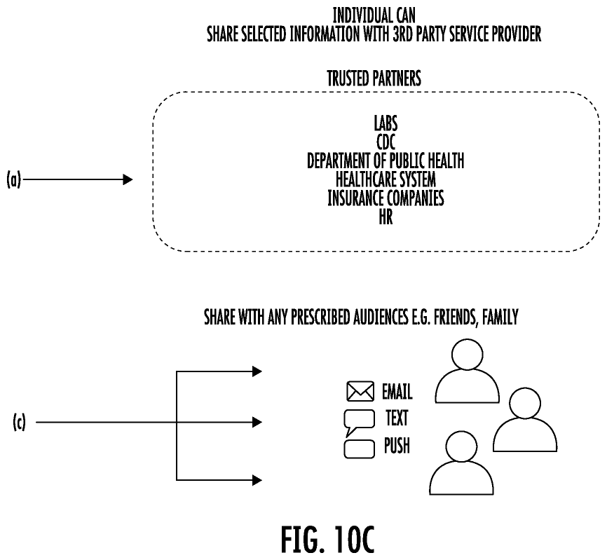

It is an additional functionality of the disclosed system to provide a “public safety cloud” for consumers, as collectively illustrated in FIGS. 10A-10C. This feature allows invitation of third parties to share information. For example, third-party insurance company, healthcare provider, and mechanic can receive information regarding an accident. This feature may also allow the authentication of data being shared with a third-party, such as information on the Internet (e.g., Facebook®, LinkedIn®, and other social media sites).

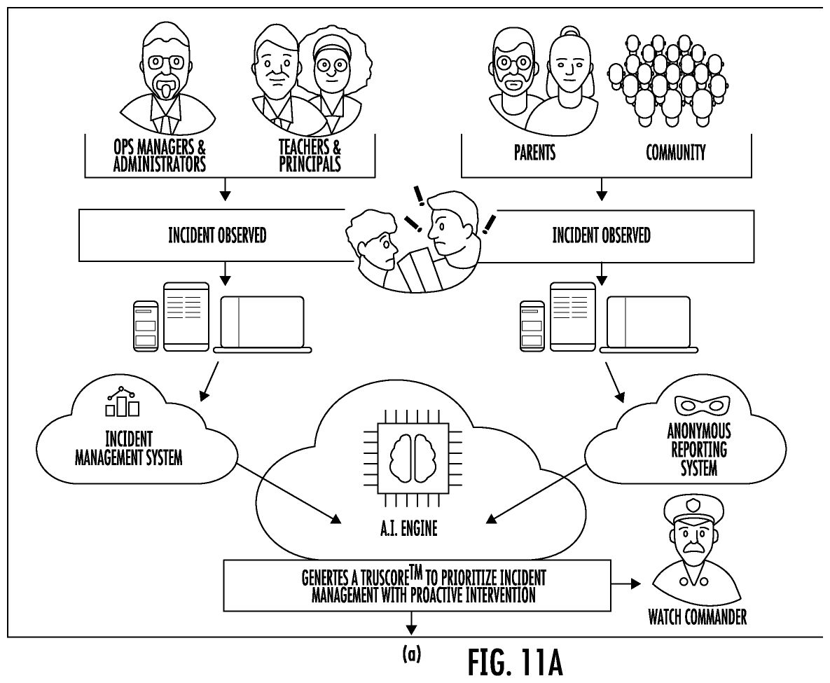

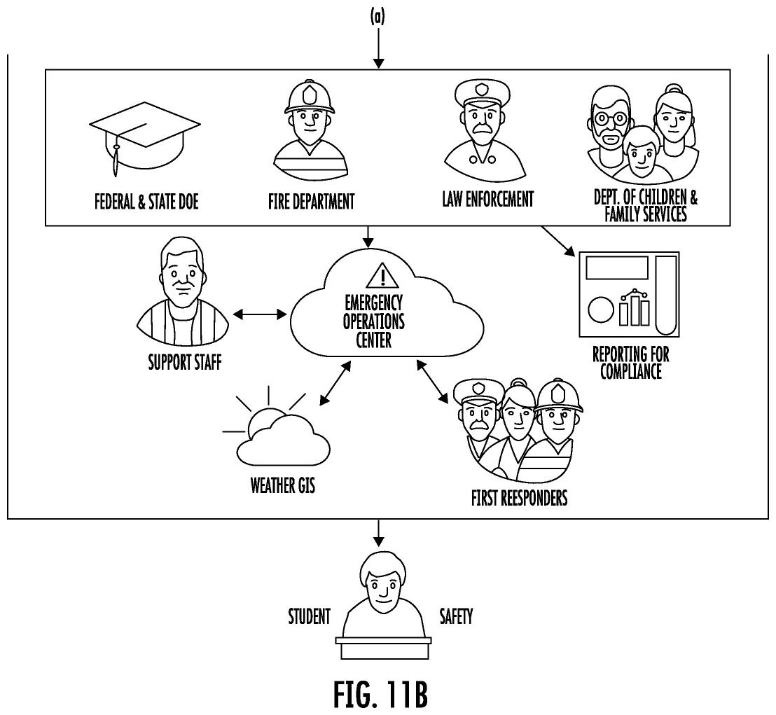

Finally, FIGS. 11A and 11B collectively are a graphic illustration of an embodiment of the disclosed Incident Management System at a high level. This flow chart illustrates the event, event reporting and scoring systems, through the management, staffing, support, and resolution of the event.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. An incident management system for coordinating resources and providing support for an event occurring within a defined area, the system comprising:
a plurality of sensors positioned within and around the defined area, inclusive of a periphery of the defined area, the plurality of sensors being capable of automatically receiving feedback within the defined area;
a cloud-based server having memory and at least one processor;
a user interface coupled to the cloud-based server;
an incident support program operating on the cloud-based server; and
instructions stored on the cloud-based server memory that, when executed by the at least one processor, cause the cloud-based server to perform operations comprising:
analyzing the input from the plurality of sensors;
determining a likelihood of an event occurring based on the input; and
determining a likelihood for a future event occurring based on the input.

2. The incident management system of claim 1, wherein the emergency operation center is a physical location.

3. The incident management system of claim 1, wherein the emergency operation center is a virtual location.

4. The incident management system of claim 1, wherein the plurality of sensors comprise at least one of a gunshot detector and a scream detector.

5. A method for managing an emergency comprising:
collecting situational data at a location;
sending the situational data to an emergency operation center;
identifying the situational data;
determining whether the situational data warrants a response;
addressing the situation; and
storing the situational data.

6. A system for managing an incident in real-time and post incident comprising:
an emergency operation center wherein coordination and support of incident management activities is directed;
a plurality of sensors capable of independently receiving information from the environment, identifying the information as actionable, and relaying the information to the emergency operation center;
a cloud-based server configured to communicate with the plurality of sensors, mobile devices, and the emergency operation center; and
an emergency support system for users to handle the emergency by providing notification, communication, and collaboration functions.

7. The incident management system of claim 6, wherein the emergency operation center is a physical location.

8. The incident management system of claim 6, wherein the emergency operation center is a virtual location.

9. The incident management system of claim 6, wherein the plurality of sensors includes a gunshot detector.

10. The incident management system of claim 6, wherein the plurality of sensors includes a scream detector.

11. A method for scoring credibility of an incident through geolocation information, the method comprising:
placing a pattern of sensors in a specified location;
collecting data from the sensors in the location;
sending the data to an emergency operation center;
categorizing the data;
identifying certain patterns in the data;
assigning each of the certain patterns a credibility value; and
addressing the situation if the pattern reaches a certain credibility value.
